(19) United States
(12) Patent Application Publication
(10) Pub. No.: US 2025/0133245 A1
(43) Pub. Date: Apr. 24, 2025

(54) REMOTE RENDERED CONTENT DELIVERY OPTIMIZATION

(71) Applicant: AT&T Mobility II LLC, Atlanta, GA (US)

(72) Inventor: Eric Petajan, Watchung, NJ (US)

(21) Appl. No.: 18/918,034

(22) Filed: Oct. 16, 2024

Related U.S. Application Data
(60) Provisional application No. 63/591,398, filed on Oct. 18, 2023.

(51) Int. Cl. H04N 21/2343; A63F 13/355

(52) U.S. Cl. CPC H04N 21/2343; A63F 13/355

(57) ABSTRACT

A processing system including at least one processor may generate a plurality of visual tracks from a source visual content, where the plurality of visual tracks comprises visual tracks of different visual quality levels and with different intra frame offsets, apply at least one network condition within a communication network, transmit one or more visual streams to one or more client devices via the communication network, where the one or more visual streams includes frames selected from among the plurality of visual tracks, and measure at least one quality metric for at least one of the one or more visual streams in accordance with the applying of the at least one network condition within the communication network.

### CROSS-REFERENCE TO RELATED APPLICATIONS

This application claims priority to U.S. Provisional Patent Application Ser. No. 63/591,398, filed Oct. 18, 2023, which is herein incorporated by reference in its entirety.

The present disclosure relates generally to cloud/network-based gaming and extended reality applications, and more particularly to methods, computer-readable media, and apparatuses for measuring at least one quality metric in accordance with one or more visual streams including frames selected from among a plurality of visual tracks generated from a source visual content with different visual quality levels and with different intra frame offsets, and to methods, computer-readable media, and apparatuses for transmitting a second plurality of frames including an initial frame comprising at least a second intra frame from a second encoder following a transmission of a first plurality of frames from a first encoder in response to detecting a delay associated with the first plurality of frames.

### BACKGROUND

Video game graphics can be rendered locally on a personal hardware system (console, PC, phone, etc.), or rendered remotely on servers running game engines while delivering rendered graphics via low latency video codecs. Hybrid local/remote rendering can perform optimally but is not common today. Remote rendered gaming (RRG) may also be referred to as cloud gaming. However, all online multiplayer games may involve cloud computing regardless of rendering location (e.g., client vs. cloud servers). Remoted rendered XR (augmented reality, virtual reality, 360 video, etc.) may utilize the same delivery infrastructure as RRGs. Remote rendered gaming offers several advantages compared to locally rendered games: 1) gamers can play new games without large file downloads that may be associated with complex games, and 2) games typically requiring high performance graphics processing units (GPUs) can be played on any device with video decoding capability and a high speed network connection.

### SUMMARY

In one example, the present disclosure describes a method, computer-readable medium, and apparatus for measuring at least one quality metric in accordance with one or more visual streams including frames selected from among a plurality of visual tracks generated from a source visual content with different visual quality levels and with different intra frame offsets. For example, a processing system including at least one processor may generate a plurality of visual tracks from a source visual content, where the plurality of visual tracks comprises visual tracks of different visual quality levels and with different intra frame offsets, apply at least one network condition within a communication network, transmit one or more visual streams to one or more client devices via the communication network, where the one or more visual streams include frames selected from among the plurality of visual tracks, and measure at least one quality metric for at least one of the one or more visual streams in accordance with the applying of the at least one network condition within the communication network.

In one example, the present disclosure also describes a method, computer-readable medium, and apparatus for transmitting a second plurality of frames including an initial frame comprising at least a second intra frame from a second encoder following a transmission of a first plurality of frames from a first encoder in response to detecting a delay associated with the first plurality of frames. For example, a processing system including at least one processor may transmit a first plurality of frames of a first visual quality level from a first encoder to a client device via a communication network, where the first plurality of frames is generated from a source visual content via the first encoder, where the first encoder is one a plurality of encoders including the first encoder, and where the plurality of visual frames includes at least a first intra frame and at least a first predicted frame associated with the at least the first intra frame, detect a delay associated with at least a portion of at least one of the first plurality of frames, and transmit, in response to the detecting, a second plurality of frames, where the second plurality of frames is generated from the source visual content via a second encoder of the plurality of encoders, and where the second plurality of frames includes an initial frame comprising at least a second intra frame.

### BRIEF DESCRIPTION OF THE DRAWINGS

The teaching of the present disclosure can be readily understood by considering the following detailed description in conjunction with the accompanying drawings, in which:

FIG. 1 illustrates an example architecture of a remote rendered gaming (RRG) testing and optimization system related to the present disclosure;

FIG. 2 illustrates an example of pre-encoded visual streams/tracks at various visual quality (VQ) levels and at different intra frame offsets;

FIG. 3 illustrates an example encoding configuration for RRG testing;

FIG. 4 illustrates an example of server/client metadata exchange for RRG;

FIG. 5 illustrates a flowchart of an example method for measuring at least one quality metric in accordance with one or more visual streams including frames selected from among a plurality of visual tracks generated from a source visual content with different visual quality levels and with different intra frame offsets;

FIG. 6 illustrates a flowchart of an example method for transmitting a second plurality of frames including an initial frame comprising at least a second intra frame from a second encoder following a transmission of a first plurality of frames from a first encoder in response to detecting a delay associated with the first plurality of frames; and

FIG. 7 illustrates an example high-level block diagram of a computing device specifically programmed to perform the steps, functions, blocks, and/or operations described herein.

To facilitate understanding, identical reference numerals have been used, where possible, to designate identical elements that are common to the figures.

### DETAILED DESCRIPTION

Video game graphics can be rendered locally on a personal hardware system (console, PC, phone, etc.), or rendered remotely on servers running game engines while delivering rendered graphics via low latency video codecs. Hybrid local/remote rendering can perform optimally but is not common today. Remote rendered gaming (RRG) may also be referred to as cloud gaming, however all online multiplayer games may involve cloud computing regardless of rendering location (e.g., client vs. cloud servers). Remoted rendered XR (augmented reality, virtual reality, 360 video, etc.) may utilize the same delivery infrastructure as RRGs. Remote rendered gaming offers several advantages compared to locally rendered games: 1) gamers can play new games without large file downloads that may be associated with complex games, and 2) games typically requiring high performance graphics processing units (GPUs) can be played on any device with video decoding capability and a high speed network connection. Impediments to remote rendered gaming may include: 1) high per-player cost of cloud computing, and 2) network connections with high throughput and low latency may be needed in order to successfully compete during “twitch” games (e.g., first person shooters (FPS) or the like).

While optical fiber networking can provide sufficient performance for RRG, cellular data networks may not guarantee throughput or latency. Network slicing may improve cellular network performance enough to provide good quality of experience (QoE) for RRG players by giving RRG packets higher priority over packets that do not require high speed delivery. In one example, RRG may use adaptive bitrate in which the RRG video encoders adapt their bitrate to network conditions, which are measured periodically in the client device and transmitted back to the server that is running the encoders. However, given the high variability of cellular networks, minimization of the time delay between network throughput and latency measurements and encoder adaptation may be beneficial to avoid lost or delayed frames, or unnecessarily low video quality (VQ). In addition, given the limited uplink throughput of cellular networks (compared to downlink), the bitrate of the transmitted network measurements should be kept under the available uplink throughput. In one example, the WebRTC (Web Real-Time Communication) protocol uses RTCP (Real-Time Control Protocol, or Real-time Transport Control Protocol) for this function.

In one example, video encoder bitrate adaptation may be accomplished by changing a transform coefficient quantization step size (aka QP), the spatial resolution, and/or the frame rate. For instance, for a given video scene, there may be an optimal QP, spatial resolution, and/or frame rate, subject to the computational constraints of the encoder implementation, and license fees for more advanced codecs (e.g., H.265 (High Efficiency Video Coding (HEVC)) or the like). RRGs are black box systems from the network provider perspective. Measurement of QoE during RRG sessions may involve access to the content before encoding in order to use full reference VQ metrics and to compute the latency or age of each frame (or loss). However, third party content providers may not provide this access. Non-reference VQ metrics may be used, but with poor accuracy.

Examples of the present disclosure include testing and optimizing network slicing for RRGs using a priori bitrate and VQ metadata associated with synthetically generated test bitstreams. These bitstreams, or “tracks,” can also be generated with optimal compression efficiency in order to provide enhanced encoding performance regardless of current economic and technical constraints. Optimizing the delivery of remote rendered interactive content, e.g., RRG and XR, may be best achieved by measurement of QoE during repeated content and network conditions, which may be presently impractical with 3rd party content service providers. In contrast, in accordance with the present disclosure, synthetically generated adaptive bitrate and resolution video streams/tracks with known bitrate switching points that are synchronized with network attenuation and slicing changes may enable identification of optimal designs and associated performance gains for network operators and content providers.

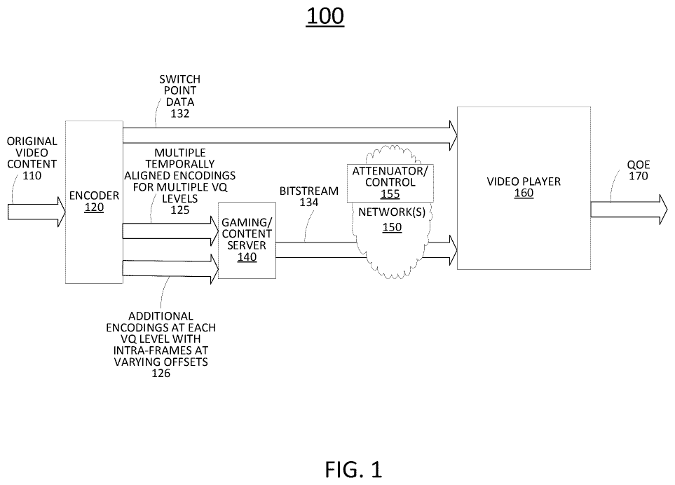

The accurate measurement of QoE during remote rendered interactive visual sessions enables optimal delivery, which improves customer experiences and reduces the network load of inefficient delivery, particularly over mobile networks. A virtually unlimited number of different video content and network conditions can be tested using this approach. The use of repeatable rendering of virtual environments (e.g., games and VR) also enables testing the benefits of advanced compression and frame interpolation techniques in a network slicing context. These and other aspects of the present disclosure are discussed in greater detail below in connection with the examples of FIGS. 1-7.

FIG. 1 illustrates an example architecture of an RRG testing and optimization system 100, in accordance with the present disclosure. For instance, FIG. 1 illustrates a simulation of an RRG session or XR session using synthetically generated visual streams with known bitrate and resolution switch points. In particular, FIG. 1 illustrates that in one example, the original video content 110 is recorded at a highest quality e.g., from a camera, game console, or viewport of a VR environment. It should be noted that as referred to herein, “video” may include various types of non-static visual content, such as camera-recorded video, AI/ML generative video/visual content, gaming scenes with animated aspects including backgrounds, bots or non-player characters, player controlled visual objects, such as avatars, projectiles, etc., and so forth. Next, multiple temporally aligned encodings for multiple VQ levels (125) of the original video content 110 may be generated such that temporal segments from different VQ levels can be concatenated together and played seamlessly. In one example, the multiple temporally aligned encodings for multiple VQ levels (125) of the original visual content 110 may be generated at a network-based processing system (e.g., an encoder 120), which may be the same as a gaming/content server 140 that streams to a client, or a different system. Additional encodings 126 may also be generated for each VQ level having intra frames (e.g., keyframes, or intra-coded frames, e.g., i-frames, or IDR frames in H.264 (Advanced Video Coding (AVC))) placed at varying intervals in order to provide alternative concatenated bitstreams. Notably, this enables intra frames to be optimally placed after a loss of packets or frames during dynamic network conditions. Switch point data 132 may be sent to video player 160 and/or to another processing system that may compute QoE measurements. In any case, a bitstream 134 of frames from one or more VQ levels (e.g., selected from 125 and 126) may be streamed over a network 150, e.g., from a gaming/content server 140.

In a testing scenario, network conditions may be controlled and repeatable, e.g., using network attenuator and control 155 over network 150 (e.g., including a Wi-Fi and/or a cellular network), and orchestrated with bitrate/VQ switching while QoE 170 is measured at the client video player 160, e.g., by comparing the original video content 110 with a screen recording at the client device, e.g., video player 160, after frame-by-frame alignment. In one example, the network attenuator and control 155 may include a synthetic traffic generator, an application/user interaction simulator, a router functionality that may implement packet drop/packet loss, delay/jitter, artificial bandwidth restrictions, and so forth. The temporal offset between the original/reference frames and the screen recorded frames (a.k.a. “distorted”) provides the latency or age of each frame which may be due to either a given frame being late or dropped. In both cases, the last received frame may be repeated. VQ metrics, e.g., video multimethod assessment fusion (VMAF) or the like, may be computed for each distorted-reference pair. In one example, QoE 170 may then be computed by the client video player 160 and/or by another system receiving the original reference frames 110, screen recorded frames, and switch point data 132, e.g., using frame age and VMAF scores as input.

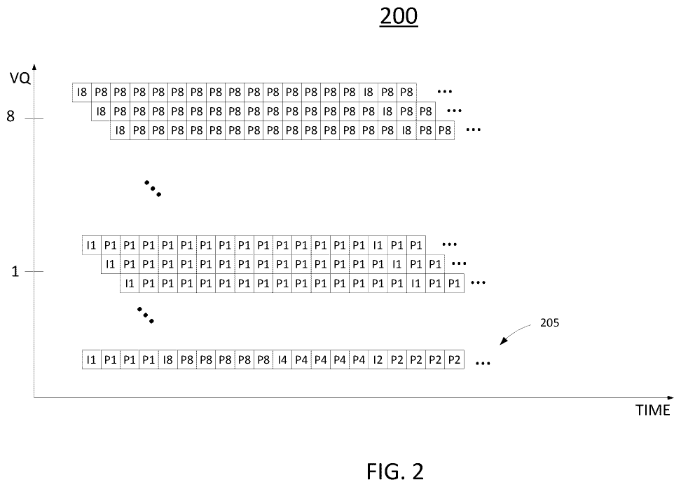

FIG. 2 shows an example set 200 of 8 VQ levels (1-8) where multiple versions of each VQ level are encoded, starting with a keyframe/intra frame at each of N frame times/time intervals (e.g., I1, I2, . . . , I8) followed by a sequence of predicted frames (e.g., P1, P2, . . . , P8). For instance, in the example of FIG. 2, each intra frame may be followed by 15 predicted frames in a keyframe interval or group of pictures (GOP). It should be noted that examples of the present disclosure may relate to various types of encodings/codecs, such as H.264 (Advanced Video Coding (AVC)), H.265 (High Efficiency Video Coding (HEVC), etc. Thus, as referred to herein, a predicted frame may comprise a p-frame, a b-frame (e.g., a bidirectional predicted frame), or any other predicted frame type (e.g., a non-keyframe) in various examples. In any case, the example set 200 of FIG. 2 provides 8×N encodings/tracks, which may be stored in preparation of selection of segments for transmission. In one example, N may be the number of frames in a keyframe interval/GOP. This configuration allows any encoding latency and transmission latency of packet delay and loss statistics from the client player to be simulated. As noted above, the availability of intra frames for each VQ level for each frame (e.g., for each time interval) enables intra frames to be optimally placed after a loss of packets or frames during dynamic network conditions. In particular, an intra frame may be transmitted in response to packet loss or the like.

It should also be noted that a packet loss or other issues, such as buffer depletion, etc. may generally result in a change in VQ level (e.g., to a lower VQ level). For instance, in the example transmission sequence 205 selected from the set 200 of 8×N encodings/tracks, it can be seen that an intra frame (I1) from VQ level 1 is followed by three predicted frames (P1) from the same VQ level 1. In addition, after the third predicted frame (P1), an intra frame (I8) from VQ level 8 is transmitted, followed by 5 predicted frames (P8) from the same VQ level. For instance, a transmission may be moved to a highest VQ level 8 as network conditions permit (e.g., as notified from the client device/player). However, after the 5^{th} predicted frame of VQ level 8, the server may receive notification from the client device/player to drop to a lower VQ level, e.g., VQ level 4. For instance, this may be the result of detected packet loss, packet delay, buffer depletion, etc. Thus, an intra frame (I4) may be transmitted in the 11^{th} time slot, followed by 4 predicted frames (P4) at the same VQ level 4. The sequence 205 may continue with an intra frame (I2) of VQ level 2 transmitted in the 16^{th} time slot, followed by four (or more) predicted frames (P2) at the same VQ level 2. For example, the server may receive a notification from the client device/player to drop to an even lower VQ level due to continued degradation of network conditions, or the like.

It should be noted that FIG. 2 illustrates just one example of a set 200 of tracks at different VQ levels and different intra frame offsets, and that other, further, and different examples may have different configurations. For instance, in one example, a number of tracks per VQ level, “N,” may be another value less than the keyframe interval/GOP length. In one example, the keyframe interval/GOP length may be different for different VQ levels, and so forth. Thus, these and other modifications are all contemplated within the scope of the present disclosure.

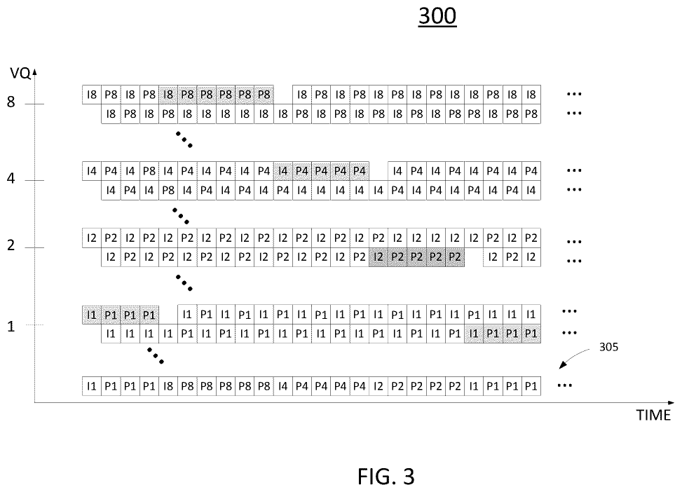

FIG. 3 illustrates an encoding configuration 300 for practical real-time implementation assuming that the transmission latency of packet delay and loss statistics from the client player is less than two frame times/time units. In particular, for each VQ level (e.g., 1-8) a server may provide a sequence of keyframes, e.g., intra frames (i-frames) and predicted frames (e.g., p-frames and/or b-frames, etc.) at a given VQ level from a first encoder. In one example, a second encoder may generate intra frames on an ongoing basis in the event that an intra frame should be sent, e.g., in response to packet loss or the like, prior to the next intended intra frame from the first encoder being available. Additional predicted frames may be generated and sent from the second encoder after switching to the second encoder. It should be noted that respective first encoders for each VQ level and respective second encoders for each VQ level may be synchronized. As such, if an intra frame is to be sent prior to a next intended intra frame from the first encoder for a given VQ level, a change in VQ level may also be applied. In one example, after a switch to an intra frame from the second encoder, the second encoder may become “primary” and the first encoder may become “secondary” or “backup” (and likewise for first and second encoders from all of the VQ levels). It should be noted that two encoders per VQ level may be implemented in the example of FIG. 3, based upon an anticipated packet delay or loss less than two frame times/time units. For an anticipated packet delay or loss less than three frame times/time units, three encoders per VQ level may be used, and so forth. As such, the number of encoders/track per VQ level may be less than the keyframe interval/GOP length.

Current RRG systems may not be able to adapt bitrate/VQ quickly enough to keep the bitrate just under the throughput and latency limits of the network. This limitation may be due to both technology challenges and economics of cloud computing. However, effective parallel encoding with stream/track switching in accordance with the present disclosure may overcome these challenges, and in a cost effective manner. In one example, client decoders may also store more past decoded frames to be used as reference intra frames to enable more motion-compensated predicted frames, which are much smaller than intra frames.

An alternative source of repeatable, original video is from a game engine or virtual reality system where graphics and animation can be replayed from the same points of view (PoV). Additional bitrate reductions and computational efficiencies may be developed with synthetic visual content generation by converting PoV transform data into frame interpolation data in the decoder. In one example, both upstream and downstream metadata can be highly compressed and given higher priority than traditional video bitstream data using network slicing.

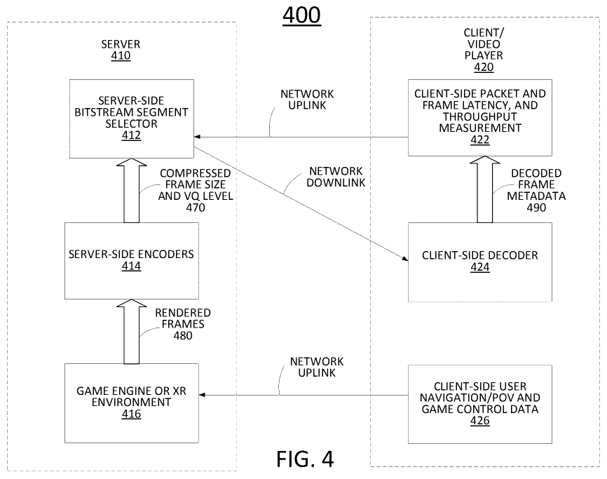

As illustrated in FIG. 4, several metadata streams may be used in a RRG system 400 comprising a server 410 and client/video player 420 including: (1) compressed frame size and VQ level data 470 from server-side encoders to server-side bitstream segment selector 412, (2) packet delay and loss statistics (e.g., client-side packet and frame latency, and throughput measurement 422) from the client/video player 420 to server side-bitstream segment selector 412 via network uplink (e.g., RTCP protocol in WebRTC), and (3) user input for navigation/PoV control (e.g., client-side user navigation/PoV and game control data 426) from the client/video player 420 to the game engine or XR environment 416 via network uplink. From such input(s), the game engine or XR environment 416 may generate rendered frames 480 for further processing via server side encoders 414. The server side bitstream segment selector 412 may select frames from one or more VQ levels for transmission to the client/video player 420. The client side decoder 424 may receive and decode the frames for rendering/display, and may further generate decoded frame metadata 490 from which client/video player 420 may determine client-side packet and frame latency, and throughput measurement 422. Notably, each metadata stream may be subject to network conditions which delay delivery and limit the optimality of the bitrate/VQ adaptation. Examples of the present disclosure enable the measurement of the benefit of optimized RRG components with respect to QoE, and identification of the points of diminishing returns. In addition, minimizing the latency of each metadata transmission may expose network bottlenecks and highlights which network elements in the cellular Radio Access Network (RAN) and core network may be upgraded for improved QoE.

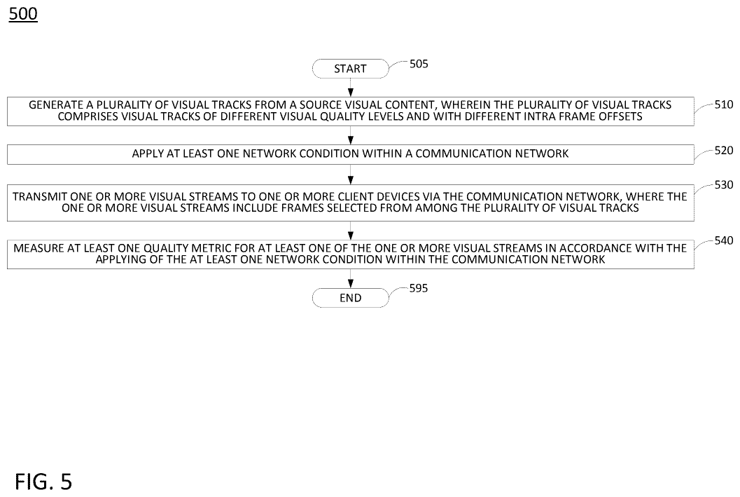

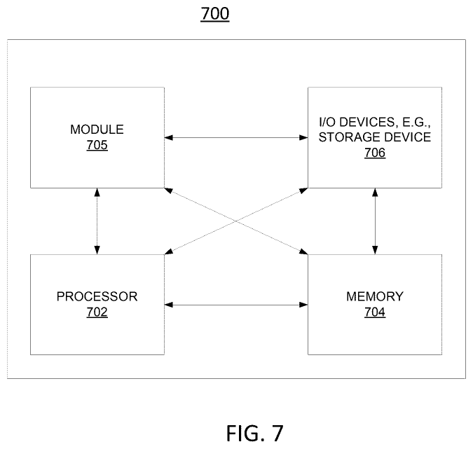

FIG. 5 illustrates a flowchart of an example method 500 for measuring at least one quality metric in accordance with one or more visual streams including frames selected from among a plurality of visual tracks generated from a source visual content with different visual quality levels and with different intra frame offsets, in accordance with the present disclosure. In one example, the method 500 is performed by a network-based server (e.g., a test platform, a game engine, an XR platform/host, etc.), or any one or more components thereof, such as a processing system, or by one of these devices in conjunction with other devices and/or components, such as client (e.g., a gaming console, an XR device, or the like), a test device (e.g., a client specifically configured for RRG test measurements or the like), and so forth. In one example, the steps, functions, or operations of method 500 may be performed by a computing device or system 700, and/or a processing system 702 as described in connection with FIG. 7 below. For instance, the computing device 700 may represent any one or more components of a test system that is/are configured to perform the steps, functions and/or operations of the method 500. For illustrative purposes, the method 500 is described in greater detail below in connection with an example performed by a processing system, such as processing system 702. The method 500 begins in step 505 and may proceed to step 510.

At step 510, the processing system may generate a plurality of visual tracks from a source visual content, where the plurality of visual tracks comprises visual tracks of different visual quality (VQ) levels and with different intra frame offsets. For instance, the plurality of visual tracks may be the same or similar to the example(s) of FIG. 2. To further illustrate, each visual track may comprise a sequence of one or more group of pictures (GOPs), wherein each GOP of the one or more GOPs comprises: at least one leading intra frame and at least one predicted frame associated with the at least one intra frame. In one example, for each VQ level of the different VQ levels, a number of the plurality of visual tracks with different intra frame offsets may be the same as a keyframe interval/GOP length. However, in another example, the number of tracks for each VQ level may be less than the keyframe interval/GOP length. In one example, the generating of the plurality of visual tracks at step 510 may be performed via one or more visual encoders, such as one or more H.264 encoders, one or more H.265 encoders, or the like. Thus, in some cases, the at least one predicted frame may comprise at least one bi-directional predicted frame (e.g., a b-frame). In one example, the processing system may comprise the encoder(s).

At step 520, the processing system may apply at least one network condition within a communication network. In one example, the applying of the network condition(s) may be via a synthetic traffic generator, an application simulator, one or more other network elements that may simulate at least one of the plurality of network conditions, e.g., a router function, or the like. The network conditions may include packet delays, packet reordering, packet loss, a throughput restriction, a network traffic volume load at one or more network elements and/or on one or more links, etc., volumes of particular types of user data traffic, e.g., a spike in voice calls following the end of a major concert or sporting event, etc., and so forth.

At step 530, the processing system may transmit one or more visual streams to one or more client devices via the communication network, where the one or more visual streams include frames selected from among the plurality of visual tracks. In one example, the frames are selected from among the plurality of visual tracks in accordance with feedback from at least one of the one or more client devices. For instance, the feedback may comprise notification of at least one of: a packet delay, e.g., a latency, a packet loss (which may be considered as a type of latency or delay), a throughput measure, a VMAF metric, or the like, e.g., with respect to the reception of the one or more visual streams. In another example, the selection of frames from different VQ levels may not be based on any feedback, but could involve testing of all different combinations, or selected combinations of VQ levels and network conditions, as well as switches between different VQ levels with various levels of network conditions, e.g., testing all combinations of these factors or selected combinations of these factors.

At step 540, the processing system may measure at least one quality metric for at least one of the one or more visual streams in accordance with the applying of the at least one network condition within the communication network. For instance, the at least one quality metric may be a visual quality metric comprising at least one of: a VMAF metric or a quality of experience (QOE) metric (which could be computed based on frame age and VMAF score, or a plurality of frame age plus VMAF scores for different distorted-reference pairs as discussed above).

Following step 540, the method 500 may proceed to step 595 where the method ends.

It should be noted that the method 500 may be expanded to include additional steps, or may be modified to replace steps with different steps, to combine steps, to omit steps, to perform steps in a different order, and so forth. For instance, in one example the processor may repeat one or more steps of the method 500 for additional network conditions, for additional client devices, for additional source visual contents, and so on. In one example, the method 500 may be expanded or modified to include steps, functions, and/or operations, or other features described in connection with any one or more of the example(s) of FIG. 1-4, 6, or 7, or as described elsewhere herein. Thus, these and other modifications are all contemplated within the scope of the present disclosure.

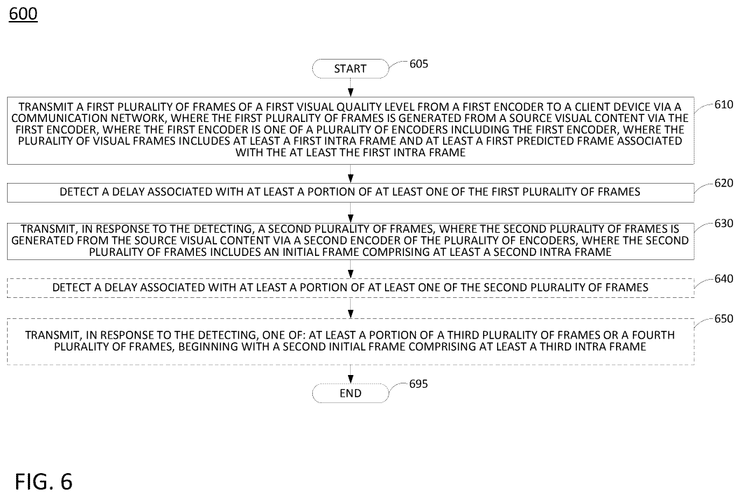

FIG. 6 illustrates a flowchart of an example method 600 for transmitting a second plurality of frames including an initial frame comprising at least a second intra frame from a second encoder following a transmission of a first plurality of frames from a first encoder in response to detecting a delay associated with the first plurality of frames, in accordance with the present disclosure. In one example, the method 600 is performed by a network-based server (e.g., a game engine, an XR platform/host, etc.), or any one or more components thereof, such as a processing system, or by one of these devices in conjunction with other devices and/or components, such as client (e.g., a gaming console, an XR device, or the like), a test device (e.g., a client specifically configured for RRG test measurements or the like), and so forth. In one example, the steps, functions, or operations of method 600 may be performed by a computing device or system 700, and/or a processing system 702 as described in connection with FIG. 7 below. For instance, the computing device 700 may represent any one or more components of a test system that is/are configured to perform the steps, functions and/or operations of the method 600. For illustrative purposes, the method 600 is described in greater detail below in connection with an example performed by a processing system, such as processing system 702. The method 600 begins in step 605 and may proceed to step 610.

At step 610, the processing system may transmit a first plurality of frames of a first visual quality (VQ) level from a first encoder to a client device via a communication network, where the first plurality of frames is generated from a source visual content via the first encoder, where the first encoder is one of a plurality of encoders including the first encoder, and where the plurality of visual frames includes at least a first intra frame and at least a first predicted frame associated with the at least the first intra frame.

At step 620, the processing system may detect a delay associated with at least a portion of at least one of the first plurality of frames. In one example, the detecting of the delay may be in accordance with feedback from the client device. For instance, the delay may comprise a packet loss. Alternatively, or in addition, the detecting of the delay may comprise detecting a drop in a throughput measure, e.g., below a threshold or below a percentage from a previous measurement, or the like.

At step 630, the processing system may transmit a second plurality of frames in response to the detecting of the delay, where the second plurality of frames may be generated from the source visual content via a second encoder of the plurality of encoders, and where the second plurality of frames includes an initial frame comprising at least a second intra frame. For instance, in one example, the second plurality of frames may be encoded at a second VQ level, e.g., that is of a lesser quality than the first visual quality level. In other words, the second encoder may encode the second plurality of frames at the second VQ level. For instance, the processing system may include at least two encoders per VQ level, which may generate sequences of alternating keyframes, e.g., intra frames, and predicted frames with an offset such that for any time interval/frame slot, an intra frame may be available from at least one of the encoders of that VQ level. For example, the processing system may include an encoding configuration such as illustrated in FIG. 3. To further illustrate, in another example, the second plurality of frames may be encoded at the first VQ level. For instance, it may be possible that an overall QoE may be highest by staying at the same VQ level, even if there is some amount of packet delay or loss versus switching to the next lowest VQ level, where there may be no packet delay or loss, but where the overall QoE is less than staying at the higher VQ level. Thus, the processing system may in some cases choose to not switch VQ levels in response to the detected delay. In such case, a second encoder for the first VQ level may continue to generate intra frames on an ongoing basis for each time unit following a transmission of a frame of the first plurality of frames until the detecting of the delay at step 620. In response to the detecting of the delay, the second encoder may become the active encoder and then generate predicted frames of the second plurality of frames following the initial frame comprising an intra frame of the second plurality of frames.

Likewise, at least a third encoder may encode a third plurality of frames at a third visual quality level, and at least a fourth encoder may encode a fourth plurality of frames at the third visual quality level with a different intra frame offset than the third plurality of frames. For example, the tracks from these encoders may remain available and on standby such that an intra frame from the third VQ level is always available for any time interval as may be desired. For instance, at a later time, the processing system may determine to drop to the third VQ level (which may be of lesser quality than the second VQ level).

In this regard, in one example, the method 600 may further include optional step 640 in which the processing system may detect a delay associated with at least a portion of at least one of the second plurality of frames. For instance, optional step 640 may comprise the same or similar operations as step 620 as discussed above.

At optional step 650, the processing system may transmit, in response to the detecting of the delay at optional step 640, one of: at least a portion of the third plurality of frames or the fourth plurality of frames, beginning with a “second” initial frame comprising at least a third intra frame (where “second” and “third” are merely labels to distinguish from the other intra frames discussed above). For instance, whichever of the third encoder or the fourth encoder generates an intra frame of the third VQ level for the time interval in question may become active and have the respective third plurality of frames or fourth plurality of frames queued for transmission. In addition, the selected encoder may begin generating an extended sequence of predicted frames following the “second” initial intra frame, and so forth with respect to a keyframe interval/GOP. In other words, if there is no VQ level switch prior to the completion of a keyframe interval/GOP, then another intra frame may be generated and transmitted followed by a plurality of predicted frames, and so forth.

Following step 630 or optional step 650, the method 600 may proceed to step 695 where the method ends.

It should be noted that the method 600 may be expanded to include additional steps, or may be modified to replace steps with different steps, to combine steps, to omit steps, to perform steps in a different order, and so forth. For instance, in one example the processor may repeat one or more steps of the method 600 for an additional duration of a source visual content, additional network conditions, for additional client devices, for additional source visual contents, and so on. In one example, the method 600 may include placing the first encoder and at least one other encoder of the first VQ level into a standby mode (e.g., alternating intra frames and predicted frames) when the second plurality of frames is of the second VQ level and is selected for transmission (and similarly with respect to the second encoder and at least one other encoder of the second VQ level when frames of the third VQ level are selected for transmission). In one example, the method 600 may further include detecting a positive change in network conditions and switching to a higher VQ level as described above. In one example, the method 600 may be expanded or modified to include steps, functions, and/or operations, or other features described in connection with any one or more of the example(s) of FIG. 1-5 or 7, or as described elsewhere herein. Thus, these and other modifications are all contemplated within the scope of the present disclosure.

In addition, although not specifically specified, one or more steps, functions, or operations of the example method 500 or the example method 600 may include a storing, displaying, and/or outputting step as required for a particular application. In other words, any data, records, fields, and/or intermediate results discussed in the method(s) can be stored, displayed, and/or outputted either on the device executing the method or to another device, as required for a particular application. Furthermore, steps, blocks, functions or operations in FIGS. 5 and 6 that recite a determining operation or involve a decision do not necessarily require that both branches of the determining operation be practiced. In other words, one of the branches of the determining operation can be deemed as an optional step. Furthermore, steps, blocks, functions or operations of the above described method(s) can be combined, separated, and/or performed in a different order from that described above, without departing from the examples of the present disclosure.

FIG. 7 depicts a high-level block diagram of a computing system 700 (e.g., a computing device or processing system) specifically programmed to perform the functions described herein. For example, any one or more components, devices, and/or systems illustrated in FIGS. 1-4 or described in connection with FIGS. 5-6, may be implemented as the computing system 700. As depicted in FIG. 7, the computing system 700 comprises a hardware processor element 702 (e.g., comprising one or more hardware processors, which may include one or more microprocessor(s), one or more central processing units (CPUs), and/or the like, where the hardware processor element 702 may also represent one example of a “processing system” as referred to herein), a memory 704, (e.g., random access memory (RAM), read only memory (ROM), a disk drive, an optical drive, a magnetic drive, and/or a Universal Serial Bus (USB) drive), a module 705 for measuring at least one quality metric in accordance with one or more visual streams including frames selected from among a plurality of visual tracks generated from a source visual content with different visual quality levels and with different intra frame offsets and/or for transmitting a second plurality of frames including an initial frame comprising at least a second intra frame from a second encoder following a transmission of a first plurality of frames from a first encoder in response to detecting a delay associated with the first plurality of frames, and various input/output devices 706, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 702 is shown, the computing system 700 may employ a plurality of hardware processor elements. Furthermore, although only one computing device is shown in FIG. 7, if the method(s) as discussed above is implemented in a distributed or parallel manner for a particular illustrative example, e.g., the steps of the above method(s) or the entire method(s) are implemented across multiple or parallel computing devices, then the computing system 700 of FIG. 7 may represent each of those multiple or parallel computing devices. Furthermore, one or more hardware processor elements (e.g., hardware processor element 702) can be utilized in supporting a virtualized or shared computing environment. The virtualized computing environment may support one or more virtual machines which may be configured to operate as computers, servers, or other computing devices. In such virtualized virtual machines, hardware components such as hardware processors and computer-readable storage devices may be virtualized or logically represented. The hardware processor element 702 can also be configured or programmed to cause other devices to perform one or more operations as discussed above. In other words, the hardware processor element 702 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer-readable instructions pertaining to the method(s) discussed above can be used to configure one or more hardware processor elements to perform the steps, functions and/or operations of the above disclosed method(s). In one example, instructions and data for the present module 705 for measuring at least one quality metric in accordance with one or more visual streams including frames selected from among a plurality of visual tracks generated from a source visual content with different visual quality levels and with different intra frame offsets and/or for transmitting a second plurality of frames including an initial frame comprising at least a second intra frame from a second encoder following a transmission of a first plurality of frames from a first encoder in response to detecting a delay associated with the first plurality of frames, e.g., via a machine learning algorithm (e.g., a software program comprising computer-executable instructions) can be loaded into memory 704 and executed by hardware processor element 702 to implement the steps, functions or operations as discussed above in connection with the example method(s). Furthermore, when a hardware processor element executes instructions to perform operations, this could include the hardware processor element performing the operations directly and/or facilitating, directing, or cooperating with one or more additional hardware devices or components (e.g., a co-processor and the like) to perform the operations.

The processor (e.g., hardware processor element 702) executing the computer-readable instructions relating to the above described method(s) can be perceived as a programmed processor or a specialized processor. As such, the present module 705 for measuring at least one quality metric in accordance with one or more visual streams including frames selected from among a plurality of visual tracks generated from a source visual content with different visual quality levels and with different intra frame offsets and/or for transmitting a second plurality of frames including an initial frame comprising at least a second intra frame from a second encoder following a transmission of a first plurality of frames from a first encoder in response to detecting a delay associated with the first plurality of frames (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium may comprise a physical device, a hardware device, or a device that is discernible by the touch. More specifically, the computer-readable storage device or medium may comprise any physical devices that provide the ability to store information such as instructions and/or data to be accessed by a processor or a computing device such as a computer or an application server.

While various examples have been described above, it should be understood that they have been presented by way of example only, and not limitation. Thus, the breadth and scope of a preferred example should not be limited by any of the above-described examples, but should be defined only in accordance with the following claims and their equivalents.

What is claimed is:

1. A method comprising:
generating, by a processing system including at least one processor, a plurality of visual tracks from a source visual content, wherein the plurality of visual tracks comprises visual tracks of different visual quality levels and with different intra frame offsets;
applying, by the processing system, at least one network condition within a communication network;
transmitting, by the processing system, one or more visual streams to one or more client devices via the communication network, wherein the one or more visual streams include frames selected from among the plurality of visual tracks; and
measuring, by the processing system, at least one quality metric for at least one of the one or more visual streams in accordance with the applying of the at least one network condition within the communication network.

2. The method of claim 1, wherein for each visual quality level of the different visual quality levels, a number of the plurality of visual tracks with different intra frame offsets is the same as a keyframe interval.

3. The method of claim 1, wherein the generating of the plurality of visual tracks is performed via one or more visual encoders.

4. The method of claim 3, wherein the one or more visual encoders comprises at least one of:
a H.264 encoder; or
a H.265 encoder.

5. The method of claim 1, wherein each visual track comprises a sequence of one or more group of pictures, wherein each group of pictures of the one or more group of pictures comprises: at least one intra frame and at least one predicted frame associated with the at least one intra frame.

6. The method of claim 5, wherein the at least one predicted frame comprises at least one bi-directional predicted frame.

7. The method of claim 1, wherein the applying is via at least one of:
a synthetic traffic generator;
an application simulator; or
at least one network element that may simulate at least one of the plurality of network conditions.

8. The method of claim 1, wherein the frames are selected from among the plurality of visual tracks in accordance with feedback from at least one of the one or more client devices.

9. The method of claim 8, wherein the feedback comprises notification of at least one of:
a packet delay;
a packet loss; or
a throughput measure; or
a visual quality metric.

10. The method of claim 1, wherein the at least one quality metric comprises at least one of:
a video multimethod assessment fusion metric; or
a quality of experience metric.

11. A non-transitory computer-readable medium storing instructions which, when executed by a processing system including at least one processor, cause the processing system to perform operations, the operations comprising:
generating a plurality of visual tracks from a source visual content, wherein the plurality of visual tracks comprises visual tracks of different visual quality levels and with different intra frame offsets;
applying at least one network condition within a communication network;
transmitting one or more visual streams to one or more client devices via the communication network, wherein the one or more visual streams includes frames selected from among the plurality of visual tracks; and
measuring at least one quality metric for at least one of the one or more visual streams in accordance with the applying of the at least one network condition within the communication network.

12. A method comprising:
transmitting, by a processing system including at least one processor, a first plurality of frames of a first visual quality level from a first encoder to a client device via a communication network, wherein the first plurality of frames is generated from a source visual content via the first encoder, and wherein the first encoder is one a plurality of encoders including the first encoder, wherein the plurality of visual frames includes at least a first intra frame and at least a first predicted frame associated with the at least the first intra frame;
detecting, by the processing system, a delay associated with at least a portion of at least one of the first plurality of frames; and
transmitting, by the processing system in response to the detecting, a second plurality of frames, wherein the second plurality of frames is generated from the source visual content via a second encoder of the plurality of encoders, wherein the second plurality of frames includes an initial frame comprising at least a second intra frame.

13. The method of claim 12, wherein the second encoder generates intra frames on an ongoing basis for each time unit following a transmission of a frame of the first plurality of frames until the detecting.

14. The method of claim 13, wherein the second plurality of frames is encoded at the first visual quality level.

15. The method of claim 12, wherein the second plurality of frames is encoded at a second visual quality level.

16. The method of claim 15, wherein at least a third encoder encodes a third plurality of frames at the third visual quality level, and wherein at least a fourth encoder encodes a fourth plurality of frames at the third visual quality level with a different intra frame offset than the third plurality of frames.

17. The method of claim 16, further comprising:
detecting, by the processing system, a delay associated with at least a portion of at least one of the second plurality of frames; and
transmitting, by the processing system in response to the detecting, one of: at least a portion of the third plurality of frames or the fourth plurality of frames, beginning with a second initial frame comprising at least a third intra frame.

18. The method of claim 12, wherein the detecting of the delay is in accordance with feedback from the client device.

19. The method of claim 12, wherein the delay comprises a packet loss.

20. The method of claim 12, wherein the detecting of the delay comprises a detecting a drop in a throughput measure.
